(19) United States
(12) Patent Application Publication
(10) Pub. No.: US 2007/0173164 A1
(43) Pub. Date: Jul. 26, 2007

(54) Adaptive, content-based discharge of a field emission display

(76) Inventor: Scott V. Johnson, Scottsdale, AZ (US)

Correspondence Address: INGRASSIA FISHER & LORENZ, P.C., 7150 E. CAMELBACK, STE. 325, SCOTTSDALE, AZ, 85251, US

(21) Appl. No.: 11/341,931

(22) Filed: Jan. 26, 2006

(51) Int. Cl. H01J 9/44; H01J 9/00

(52) U.S. Cl. 445/6; 445/5; 445/3

(57) ABSTRACT

A method is provided for reducing power and audible noise during discharging of dielectric surfaces (137) of a field emission display (100, 200). The method comprises reading (302) a distribution parameter of one or more frames of video data and if (312) the distribution parameter exceeds a threshold, lowering (314) the voltage on an anode (124) and impacting electrons from a plurality of emitters (114) upon the dielectric surfaces (137).

### FIELD OF THE INVENTION

The present invention generally relates to field emission displays and more particularly to a method for reducing power and audible noise during discharging of dielectric surfaces.

### BACKGROUND OF THE INVENTION

Field emission displays are well known in the art. A field emission display includes an anode plate and a cathode plate that define a thin envelope. Typically, the anode plate and cathode plate are thin enough to necessitate some form of a spacer structure to prevent implosion of the device due to the pressure differential between the internal vacuum and external atmospheric pressure. The spacers are disposed within the active area of the device, which includes the electron emitters and phosphors.

The potential difference between the anode plate and the cathode plate is typically within a range of 300-10,000 volts. To withstand the potential difference between the anode plate and the cathode plate, the spacers typically include a dielectric material. Thus, the spacers have dielectric surfaces that are exposed to the evacuated interior of the device.

During the operation of the field emission display, electrons are emitted from the electron emitters, such as Spindt tips or carbon nanotubes, toward the anode plate. These electrons traverse the evacuated region and impinge upon phosphors positioned on the anode plate; however, some of these electrons may strike the dielectric surfaces of the spacers. In this manner, the dielectric surfaces of the spacers become charged. Typically, the dielectric spacers become positively charged because the secondary electron yield of the spacer material is initially greater than one.

Numerous problems arise due to the charging of the dielectric surfaces within a field emission display. For example, control over the trajectory of electrons adjacent to the spacers is lost. Also, the risk of electrical arcing events increases dramatically.

It is known to use electron current from the electron emitters coupled with a fixed resistance connected between the anode plate and an anode voltage source to reduce the voltage at the anode plate and cause the electrons to be attracted by the charged surfaces instead of the anode. The electrons are used to neutralize the charged surfaces. However, the electrons that bounce off of or emit secondarily from the dielectric surface also strike the phosphors, which results in a visible “flash” of light being generated at the viewing screen of the field emission display. Furthermore, the fixed resistance between the anode plate and the anode voltage source necessitates a high current to pull down the anode voltage, which results in large power losses. Conventionally, this discharge is accomplished every frame, resulting in a high current drain and a perceptive “hum”.

Accordingly, there exists a need for a method for reducing charge accumulation in a field emission display, which reduces or eliminates this visible “flash” and which reduces the power loss associated with pulling down the anode voltage.

Accordingly, it is desirable to provide a method for reducing power and audible noise during discharging of dielectric surfaces. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

An apparatus is provided for discharging dielectric surfaces of a field emission display. The method comprises determining a distribution parameter of one or more frames of video data and if the distribution parameter exceeds a threshold, lowering the voltage on an anode and impacting electrons from a plurality of emitters upon the dielectric surfaces.

### BRIEF DESCRIPTION OF THE DRAWINGS

The present invention will hereinafter be described in conjunction with the following drawing figures, wherein like numerals denote like elements, and

FIG. 1 is a cross-sectional view of a field emission display that may be used with an exemplary embodiment;

FIG. 2 is a block diagram of a field emission display device that may be used with an exemplary embodiment;

FIG. 3 is flow chart of steps of a first exemplary embodiment;

FIG. 4 is flow chart of steps of a second exemplary embodiment;

FIG. 5 is flow chart of steps of a third exemplary embodiment; and

FIG. 6 is flow chart of steps of a fourth exemplary embodiment.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A potential on an anode of a field emission display is discharged when needed (discharge mode) in order to neutralize a positive charge thereon by directing a large number of electrons from electron emitters at dielectric surfaces. The rate and frequency of discharge of the anode is based on a distribution parameter, such as the peak/average luminance value of a data bitstream (video content) that drives the electron emitters during the normal scanning (display) mode, thereby reducing the number of discharge cycles per unit time, providing for higher efficiency and lower audible noise.

FIG. 1 is a cross-sectional view of a field emission display 100 that may be used with the exemplary embodiment described herein. Field emission display 100 includes a display device 102 and an anode voltage pull-down circuit 127. Display device 102 includes a cathode plate 110 and an anode plate 122. Cathode plate 110 and anode plate 122 are spaced apart by a spacer 136. Cathode plate 110 includes a substrate 111, which can be made from glass or silicon, for example. A plurality of conductive columns 112 is disposed upon substrate 111. A dielectric layer 113 is disposed upon conductive columns 112 and further defines a plurality of wells.

One or more electron emitters 114 are disposed in each of the wells. Anode plate 122 is disposed to receive an electron current 132 emitted by electron emitters 114. The electron emitters 114 may comprise any known emitters, e.g., Spindt tips or carbon nanotubes. A plurality of conductive rows 115 are formed on dielectric layer 113 proximate to the wells. Conductive columns 112 and conductive rows 115 are used to selectively address electron emitters 114.

To facilitate understanding, FIG. 1 depicts only a few rows and one column. However, it is desired to be understood that any number of rows and columns can be employed. An exemplary number of rows for display device 102 is 240, and an exemplary number of columns is 960. Methods for fabricating cathode plates for matrix-addressable field emission displays typically comprise known lithographic techniques.

Anode plate 122 includes a transparent substrate 123 made from, for example, glass. An anode 124 is disposed on transparent substrate 123. Anode 124 is preferably made from a transparent conductive material, such as indium tin oxide. In the exemplary embodiment, anode 124 is a continuous layer that opposes the entire emissive area of cathode plate 110. That is, anode 124 opposes the entirety of electron emitters 114. Anode 124 is designed to be connected to a potential source 126, which is preferably a direct current voltage source. A plurality of phosphors 125 is disposed upon anode 124.

An output 104 of anode voltage pull-down circuit 127 is connected to an input 121 of anode 124. An input 106 of anode voltage pull-down circuit 127 is designed to be connected to potential source 126.

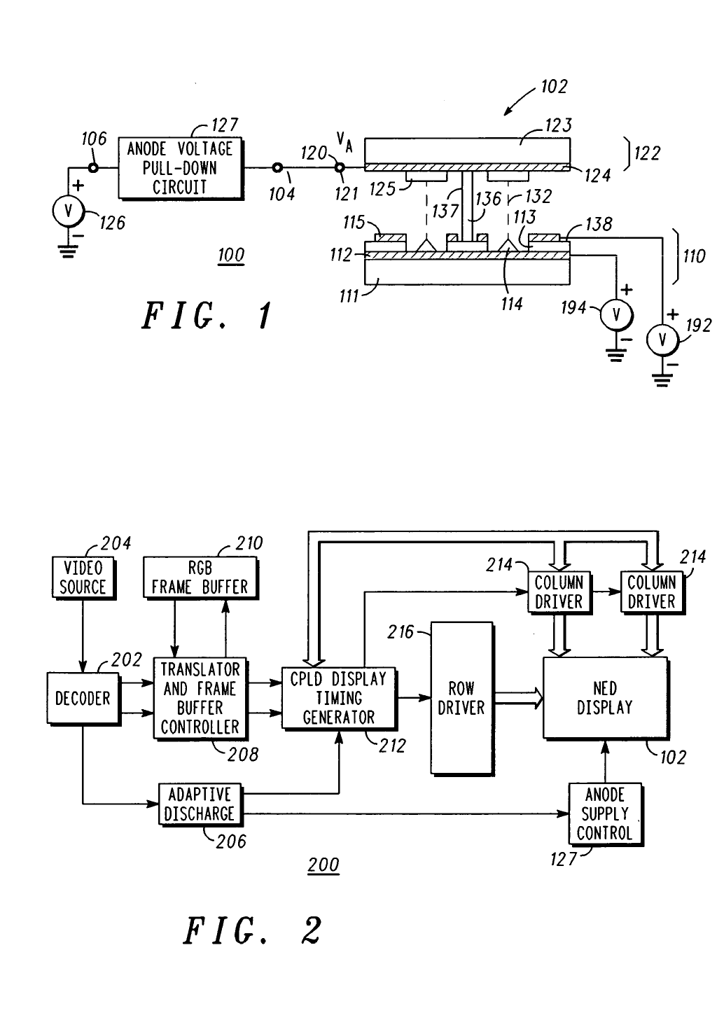

Spacers 136 are useful for maintaining a separation distance between cathode plate 110 and anode plate 122. Only one spacer 136 is depicted in FIG. 2; however, the actual number of spacers 136 depends on the structural requirements of display device 102. Spacers 136 may be made from a dielectric material, a bulk resistive material, or a combination thereof, for example. Spacers 136 may be thin plates, ribs, or any of numerous other shapes. Any dielectric surface defined by spacer 136 can become a positively eloectrostatically charged surface 137 during the operation of field emission display 100. Other surfaces, such as a surface 138 of dielectric layer 113, within display device 102 can also become positively electrostatically charged during operation of the device. These surfaces become charged because some of the electrons of electron current 132 impinge upon gas molecules that become positively ionized and impact these surfaces. If a surface has a secondary electron yield of greater than one, the surface emits more than one electron for each electron or ion received. Thus, a positive potential is developed. The method of the invention described herein is useful for reducing the charge on these surfaces, while simultaneously improving power requirements, black level, and response of potential source 126 during the steps for reducing the charge.

A voltage source 194 is connected to each of conductive columns 112. Voltage source 194 is useful for applying potentials, as defined by video data, for creating a display image and for reducing charge accumulation in display device 102. A voltage source 192 is connected to each of conductive rows 115. Voltage source 192 is useful for applying potentials for creating a display image and for reducing charge accumulation in display device 102.

It should be understood that the field emission display 100 shown is only one of many displays that may be used with the exemplary embodiment described below.

The operation of field emission display 100 is characterized by two modes of operation: a scanning mode and a discharge mode. During the scanning mode, potentials are sequentially applied to conductive rows 115. By scanning it is meant that a potential suitable for causing electron emission is selectively applied to the scanned row. Whether each of electron emitters 114 within a scanned row is caused to emit electrons depends upon the video data and the voltage applied to each column. Electron emitters 114 in the rows not being scanned are not caused to emit electrons. During the time that one of conductive rows 115 is scanned, potentials are applied to conductive columns 112 according to video data.

During the scanning mode, an anode voltage 120 (Va) which is the potential at anode 124, is selected to attract electron current 132 toward anode plate 122 and to provide a desired level of brightness of the image generated by phosphors 125. Anode voltage 120 is provided by potential source 126. In accordance with the exemplary embodiment, during the scanning mode, anode voltage 120 is held at some value which is preferably greater than 2500 volts.

During the scanning mode, most of the electrons emitted by electron emitters 114 strike anode plate 122. However, some of the emitted electrons impinge upon dielectric surfaces within the display device 102, causing the dielectric surfaces to become positively electrostatically charged. The charged surfaces cause undesirable effects, such as adversely affecting the control of electron current 132.

To achieve the discharge mode of operation of field emission display 100 in accordance with the exemplary embodiment, anode voltage 120 is reduced from a scanning mode value to a discharge mode value, and electron current 132 is increased from a scanning mode value to a discharge mode value. The discharge mode value of electron current 132 is useful for neutralizing positively electrostatically charged surfaces within display device 102. Anode voltage 120 is reduced by an amount sufficient to allow electron current 132 to be directed toward the charged surfaces 137, 138. Preferably, anode voltage 120 is reduced to about ground potential. Anode voltage pull-down circuit 127 is useful for reducing anode voltage 120 during the discharge mode of operation.

The discharge current is preferably generated by causing the entirety of electron emitters 114 to emit electrons. This is achieved by applying the appropriate emission/“on” potentials to all of rows 115 and columns 112 of cathode plate 110. Thus, the discharge current available for neutralization is equal to the product of the total number of rows 115 and the maximum emission current per row 115. The discharge current can also be generated by causing less than all of electron emitters 114 to emit electrons.

Referring to FIG. 2, a block diagram of the control circuitry 200 for the field emission display 102 includes a decoder 202 responsive to a video source 204 for decoding video images received electronically. The decoder 202 comprises a microprocessor and memory for analyzing the video image (data bitstream) and supplying the adaptive discharge circuit 206 the rate and frequency at which the anode supply control circuit 127 should discharge the anode 124 of the field emission display 102 in accordance with the exemplary embodiments. More on how this is accomplished will be discussed presently.

The decoder 202 additionally provides data to the translator and frame buffer controller 208 for scaling and image and color correction. RGB (red, green, blue) frame buffer 210 serves to hold additional frames in memory for further processing. The programmable logic device display timing generator 212 controls the timing of current applied to the column drivers 214 and row driver 216.

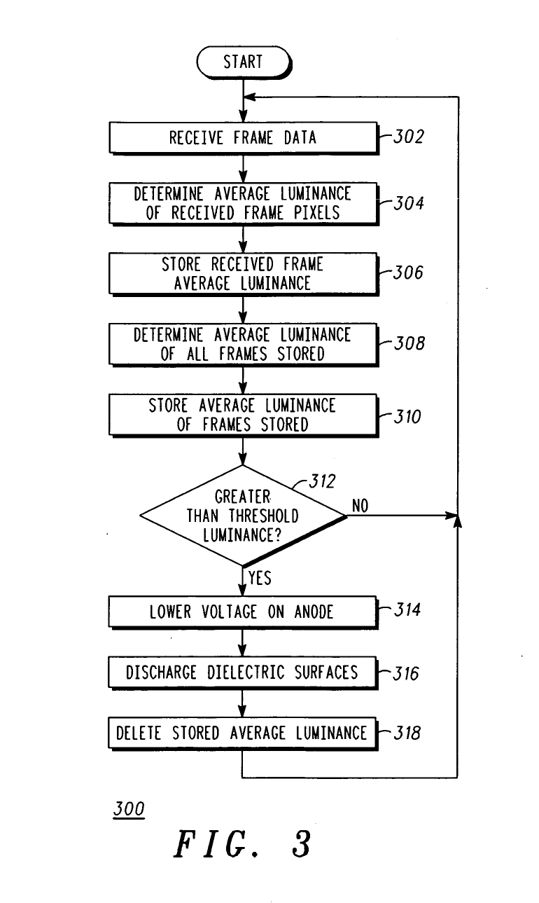

Referring to FIG. 3, the flow chart 300 of the program in the decoder 202 of a first exemplary embodiment includes the steps receiving frame data 302 (representing the video image). The frame data typically comprises eight bits for each of three colors. Each color includes a number of pixels, e.g., 1280, multiplied by the number of rows in the display. The frame data includes a word indicating the luminance for each color which could be zero for black and up to 255 for bright white, for example. The number of frames per unit time could vary, but preferably is 60 frames per second, or 16.7 milliseconds per frame.

While luminance is measured in the exemplary embodiments described herein, any distribution parameter could be used. Examples of distribution parameters other than luminance include charge level measured by an in-situ electrometer, average anode current, and peak anode current. In the case of average anode current, a sample of the anode current is measured during the frame period. In the case of electrometric charge detection, the charge level is measured during a frame period.

The average luminance of received frame pixels is determined 304 by summing the luminance of each pixel and dividing by the number of pixels. This average luminance is stored 306 in memory. The average luminance of that frame and previously stored frames is then determined 308 by summing the average luminance of each frame and dividing by the number of frames stored, which is then stored 310 in memory. If the average luminance of all stored frames is less than a threshold 312, the next frame data is received 302 and the steps are repeated. The threshold may be, for example, a percentage of total possible luminance. If the average luminance of all stored frames is greater than a threshold 312, then the voltage V_{A} on the anode 102 is removed 314, and the electron emitters 114 are made to emit electrons that strike the dielectric surfaces, thereby discharging 318, or removing a positive charge from, the dielectric surfaces. The stored average luminance data is deleted 318 from memory and the program returns to receive frame data 302. This exemplary embodiment provides for lowering the voltage V_{A} on the anode 102 and discharging the dielectric surfaces 137 only when the total luminance value reaches a threshold, and is not based on a cyclic, time based method as previously known.

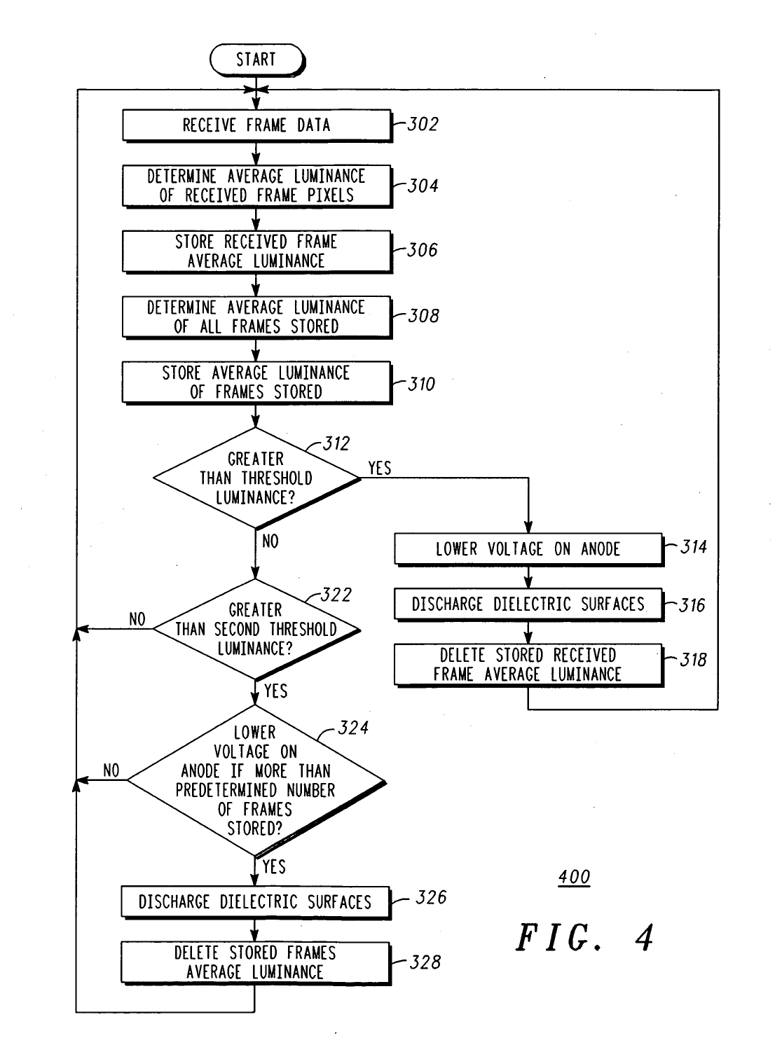

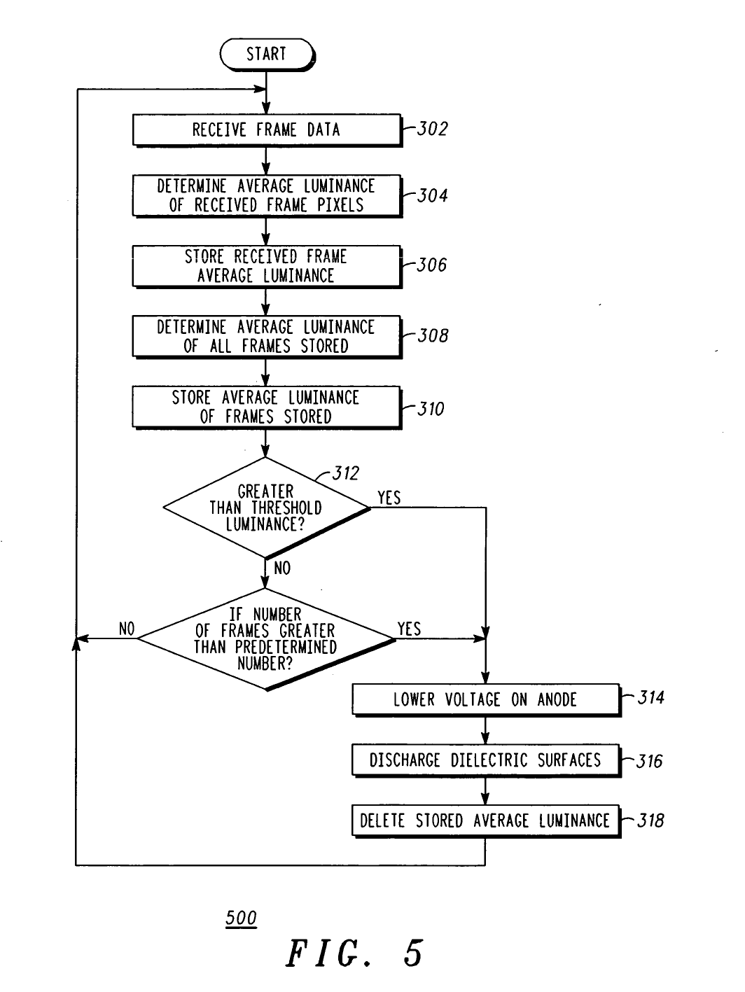

Referring to FIG. 4, the flow chart 400 of the program in the decoder 202 of a second exemplary embodiment includes the same steps 302, 304, 306, 308, 310, 312, 316, and 318 as described for FIG. 3; however, if the average luminance of all stored frames is less than the threshold 312, a determination is made if the average luminance of all stored frames is greater than a second threshold 322. If not, the program returns to the start and receives the next frame data 302. If the average luminance is greater than the second threshold 322, the voltage V_{A} is removed from the anode 102 if more than a predetermined number of frames have been stored 324. If not, the program returns to receive the next frame's data 302. If more than a predetermined number of frames have been stored, the voltage V_{A} is removed and the dielectric surfaces are discharged 326. The stored average luminance data is deleted 328 from memory and the program returns to receive frame data 302. This exemplary embodiment provides for lowering the voltage V_{A} on the anode 102 and discharging the dielectric surfaces 137 when 1) the total luminance value reaches a threshold, and 2) the total luminance value reaches a second threshold and more than a predetermined number of frames have been stored.

Referring to FIG. 5, the flow chart 500 of the program in the decoder 202 of a third exemplary embodiment includes the same steps 302, 304, 306, 308, 310, 312, 314, and 318 as described for FIG. 3; however, if the average luminance of all stored frames is less than the threshold 312, a determination is made if the number of stored frames is greater than a predetermined number of frames 332. If less than the predetermined number of frames 322, the program returns to the start to receive the next frame's data. If the average luminance of all stored frames is greater than the threshold 312, or the number of frames is greater than the predetermined number of frames 332, the voltage V_{A} is removed 314 and the dielectric surfaces are discharged 316. The stored average luminance data is deleted 318 from memory and the program returns to receive frame data 302. This exemplary embodiment provides for lowering the voltage V_{A} on the anode 102 and discharging the dielectric surfaces 137 when the total luminance value reaches a threshold, or the number of frames exceed a predetermined number.

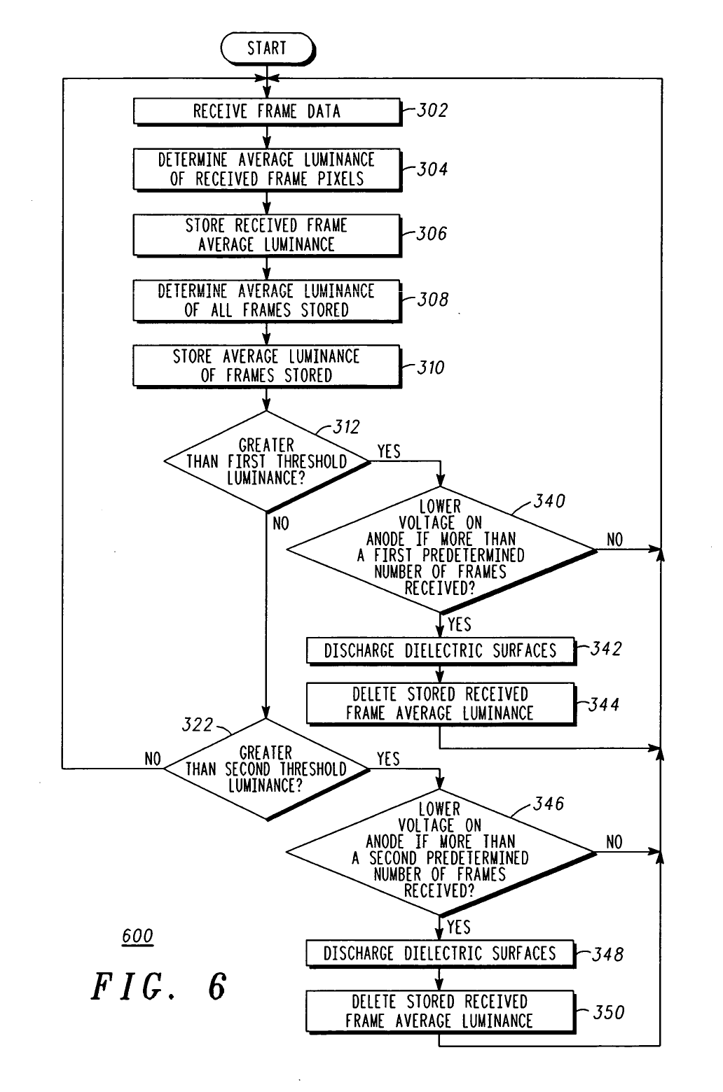

Referring to FIG. 6, the flow chart 600 of the program in the decoder 202 of a fourth exemplary embodiment includes the same steps 302, 304, 306, 308, 310, 312, and 322 as previously described for FIG. 3; however, if the average luminance of all stored frames is greater than the threshold 312, but a first predetermined number of received frames is not exceeded 340, the program returns to the start to receive the next received frame. If the average luminance of all stored frames is greater than the threshold 312, and if a first predetermined number of received frames is exceeded, the voltage V_{A} is removed 340 and the dielectric surfaces are discharged 342. The stored average luminance data is deleted 344 from memory and the program returns to receive frame data 302. If in step 322, the second threshold luminance is exceeded, the voltage V_{A} is removed 346 and the dielectric surfaces are discharged 348. The stored average luminance data is deleted 350 from memory and the program returns to receive frame data 302. This exemplary embodiment provides for lowering the voltage V_{A} on the anode 102 and discharging the dielectric surfaces 137 when 1) the total luminance value reaches a first threshold and a first predetermined number of frames is exceeded, and 2) if the total luminance reaches a second threshold and the number of frames exceeds a second predetermined number.

It has been shown that the frequency of discharging the dielectric surfaces of a field emission display may be based on distribution parameters, such as average luminance, instead of strictly being discharged after each frame or a number of frames. This method reduces power and audible noise during discharging of dielectric surfaces.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method for discharging dielectric surfaces of a field emission display, comprising the steps in sequence:
(a) determining a distribution parameter of one or more frames of video data;
(b) if the distribution parameter exceeds a first threshold:
lowering the voltage on an anode; and
impacting electrons from a plurality of emitters upon the dielectric surfaces.

2. The method of claim 1 further comprising, (c) if the distribution parameter does not exceed the first threshold, determining a distribution parameter of an additional one or more frames of video data and repeating the steps from step (b).

3. The method of claim 1 wherein the determining step comprises determining one of luminance, charge level, average anode current, and peak anode current.

4. The method of claim 1, if the distribution parameter does not exceed the first threshold, further comprising:
(c) if the distribution parameter exceeds a second threshold, and if more than a predetermined number of frames have been received:
lowering the voltage on the anode; and
impacting electrons from the plurality of emitters upon the dielectric surfaces.

5. The method of claim 4 further comprising, (d) if the distribution parameter does not exceed the second threshold, determining a distribution parameter of an additional one or more frames of video data and repeating the steps from step (b).

6. The method of claim 1, if the distribution parameter does not exceed the first threshold, further comprising:
(c) if the number of frames are greater than a pre-determined number:
lowering the voltage on the anode; and
impacting electrons from the plurality of emitters upon the dielectric surfaces.

7. The method of claim 1, if the distribution parameter does not exceed the first threshold, further comprising:
(c) if the distribution parameter exceeds a second threshold, and if more than a predetermined number of frames have been received:
lowering the voltage on the anode; and
impacting electrons from the plurality of emitters upon the dielectric surfaces.

8. A method for discharging dielectric surfaces of a field emission display, comprising the steps in sequence:
(a) reading distribution parameters from one or more frames of video data;
(b) determining a characteristic of the distribution parameters;
(c) storing the distribution parameter characteristic;
(d) if the stored distribution parameter characteristic exceeds a threshold:
lowering the voltage on an anode;
impacting electrons from a plurality of emitters upon the dielectric surfaces;
deleting the stored distribution parameter characteristic; and
repeating the method from step (a).

9. The method of claim 8, further comprising:
(e) if the distribution parameter characteristic does not exceed the threshold:
determining the distribution parameter of another frame;
recalculating the distribution parameter characteristic for the frames; and
repeating the method from step (c).

10. The method of claim 8 wherein the reading step comprises reading the luminance of each pixel of the frames and the determining step comprises determining the average luminance of the frames.

11. The method of claim 8 wherein the determining step comprises determining one of luminance, charge level, average anode current, and peak anode current.

12. The method of claim 8, if the distribution parameter does not exceed the first threshold, further comprising:
if the distribution parameter exceeds a second threshold, and if more than a predetermined number of frames have been received:
(e) lowering the voltage on the anode;
(f) impacting electrons from the plurality of emitters upon the dielectric surfaces;
(g) deleting the stored distribution parameter characteristic; and
(h) repeating the method from step (a);
if the distribution parameter does not exceed the first threshold, and if the distribution parameter does not exceed the second threshold,
(i) determining the distribution parameter of another frame;
(j) recalculating the distribution parameter characteristic for the frames; and
(k) repeating the method from step (c).

13. The method of claim 8, if the distribution parameter does not exceed the first threshold, further comprising:
if the number of frames are greater than a pre-determined number:
(e) lowering the voltage on the anode; and
(f) impacting electrons from the plurality of emitters upon the dielectric surfaces;
(g) deleting the stored distribution parameter characteristic; and
(h) repeating the method from step (a);
if the number of frames are not greater than a pre-determined number,
(i) determining the distribution parameter of another frame;
(j) recalculating the distribution parameter characteristic for the frames; and
(k) repeating the method from step (c).

14. The method of claim 8, if the distribution parameter does not exceed the first threshold, further comprising:
if the distribution parameter exceeds a second threshold, and if more than a predetermined number of frames have been received:
lowering the voltage on the anode; and
impacting electrons from the plurality of emitters upon the dielectric surfaces;
deleting the stored distribution parameter characteristic; and
repeating the method from step (a);
if the distribution parameter does not exceed the first threshold, and if the distribution parameter does not exceed the second threshold,
determining the distribution parameter of another frame;
recalculating the distribution parameter characteristic for the frames; and
repeating the method from step (c).

15. A method for operating a field emission display having an anode distally disposed from a cathode plate for displaying video during a scanning mode in response to an input comprising a series of frames, the method comprising the steps in sequence:
(a) reading a distribution parameter of a frame;
(b) calculating a characteristic of the distribution parameter;
(c) storing the characteristic;
(d) determining if the characteristic exceeds a threshold;
(e) if the stored characteristic exceeds the threshold, lowering a voltage on the anode during a discharge mode, deleting the stored characteristic, and repeating the steps from step (a);
(f) if not above the threshold, determining the distribution parameter of another frame and repeating the steps from step (b).

16. The method of claim 15 wherein the reading step comprises reading the luminance of each pixel of the frames and the calculating step comprises determining the average luminance of the frames.

17. The method of claim 15 wherein the determining step comprises determining one of luminance, charge level, average anode current, and peak anode current.

18. The method of claim 15, if the distribution parameter does not exceed the first threshold, further comprising:
if the distribution parameter exceeds a second threshold, and if more than a predetermined number of frames have been received:
(g) lowering the voltage on the anode;
(h) impacting electrons from the plurality of emitters upon the dielectric surfaces;
(i) deleting the stored distribution parameter characteristic; and
(j) repeating the method from step (a);
if the distribution parameter does not exceed the first threshold, and if the distribution parameter does not exceed the second threshold,
(k) determining the distribution parameter of another frame;
(l) recalculating the distribution parameter characteristic for the frames; and
(m) repeating the method from step (c).

19. The method of claim 15, if the distribution parameter does not exceed the first threshold, further comprising:
if the number of frames are greater than a pre-determined number:
(g) lowering the voltage on the anode;
(h) impacting electrons from the plurality of emitters upon the dielectric surfaces;
(i) deleting the stored distribution parameter characteristic; and
(j) repeating the method from step (a);
if the number of frames are not greater than a pre-determined number,
(k) determining the distribution parameter of another frame;
(l) recalculating the distribution parameter characteristic for the frames; and
(m) repeating the method from step (c).

20. The method of claim 15, if the distribution parameter does not exceed the first threshold, further comprising:
if the distribution parameter exceeds a second threshold, and if more than a predetermined number of frames have been received:
(g) lowering the voltage on the anode;
(h) impacting electrons from the plurality of emitters upon the dielectric surfaces;
(i) deleting the stored distribution parameter characteristic; and
(j) repeating the method from step (a);
if the distribution parameter does not exceed the first threshold, and if the distribution parameter does not exceed the second threshold,
(k) determining the distribution parameter of another frame;
(l) recalculating the distribution parameter characteristic for the frames; and
(l) repeating the method from step (c).
